(19) United States
(12) Patent Application Publication
(10) Pub. No.: US 2003/0072436 A1
(43) Pub. Date: Apr. 17, 2003

(54) Subscriber line interface circuitry with modified DC feed

(76) Inventors: Christopher D. Eckhoff, Austin, TX (US); Marius Goldenberg, Austin, TX (US)

Correspondence Address: William D. Davis, Davis & Associates, Box 1093, Dripping Springs, TX, 78620, US

(21) Appl. No.: 09/977,875

(22) Filed: Oct. 15, 2001

(51) Int. Cl. H04M 1/00; H04M 9/00

(52) U.S. Cl. 379/399.01

(57) ABSTRACT

A method of controlling a DC feed from a subscriber loop interface circuit (SLIC) includes the steps of switching from a normal mode DC feed following a first characteristic curve to a modified mode DC feed following a second characteristic curve when the metallic voltage (V_{M}) meets or falls below a first threshold voltage. The SLIC switches back from the modified mode to the normal mode when V_{M} meets or exceeds a second threshold voltage. In one embodiment the first and second characteristic curves are linear and have the same pre-determined slope.

### FIELD OF THE INVENTION

This invention relates to the field of telecommunications. In particular, this invention is drawn to subscriber line interface circuitry.

### BACKGROUND OF THE INVENTION

Subscriber line (or loop) interface circuits are typically found in the central office exchange of a telecommunications network. A subscriber line interface circuit (SLIC) provides a communications interface between the digital switching network of a central office and an analog subscriber line. The analog subscriber line connects to a subscriber station or telephone instrument at a location remote from the central office exchange.

The analog subscriber line and subscriber equipment form a subscriber loop. The interface requirements of an SLIC typically result in the need to provide relatively high voltages and currents for control signaling with respect to the subscriber equipment on the subscriber loop. Voiceband communications are typically low voltage analog signals on the subscriber loop. Thus the SLIC must detect and transform low voltage analog signals into digital data for transmitting communications received from the subscriber equipment to the digital network. For bi-directional communication, the SLIC must also transform digital data received from the digital network into low voltage analog signals for transmission on the subscriber loop to the subscriber equipment.

The SLIC must operate in accordance with a number of specified standards. For example, when the subscriber equipment is on hook, the SLIC should maintain a certain open circuit voltage. This open circuit voltage may be provided by a battery. When the subscriber equipment is off hook the SLIC should provide sufficient DC feed to ensure proper operation of the subscriber equipment.

Ideally, the SLIC can be used with short or long subscriber loops. If, however, the SLIC is optimized to minimize power consumption for short loops, the battery may not provide sufficient current for the maximum loop length. When optimized for longer loops, a shorter loop results in unnecessary power consumption.

### SUMMARY OF THE INVENTION

In view of limitations of known systems and methods of controlling a subscriber loop DC feed provided by a subscriber loop interface circuit are described.

One method of controlling a DC feed from a subscriber loop interface circuit (SLIC) includes the steps of switching from a normal mode DC feed following a first characteristic curve to a modified mode DC feed following a second characteristic curve when the metallic voltage meets or falls below a first threshold voltage. The SLIC switches from the modified mode to the normal mode when the metallic voltage meets or exceeds a second threshold voltage.

A subscriber loop interface circuit apparatus includes control circuitry for controlling the subscriber loop DC feed. The SLIC also includes a plurality of programmable registers storing values defining a first characteristic curve and a second characteristic curve. The control circuitry switches from a normal mode DC feed following a first characteristic curve to a modified mode DC feed following a second characteristic curve when the subscriber loop voltage meets or falls below a first threshold voltage. The control circuitry switches from the modified mode to the normal mode when the subscriber loop voltage meets or exceeds a second threshold voltage.

In one embodiment the first and second characteristic curves are linear and have the same pre-determined slope. The pre-determined slope corresponds to a pre-determined DC feed impedance. In one embodiment, the pre-determined impedance is approximately 320 Ω. In alternative embodiments, the characteristic curves may have different slopes or one or both of the curves may be curvilinear or otherwise nonlinear.

Other features and advantages of the present invention will be apparent from the accompanying drawings and from the detailed description that follows.

### BRIEF DESCRIPTION OF THE DRAWINGS

The present invention is illustrated by way of example and not limitation in the figures of the accompanying drawings, in which like references indicate similar elements and in which:

FIG. 1 illustrates one embodiment of a central office exchange including a subscriber line interface circuit (SLIC) coupling subscriber equipment to a digital switching system.

FIG. 2 illustrates one embodiment of subscriber loop DC feed characteristic.

FIG. 3 illustrates an alternative embodiment of a subscriber loop DC feed characteristic switching between a normal and a modified feed mode with hysteresis.

FIG. 4 illustrates one embodiment of a method of implementing a subscriber loop DC feed characteristic switching between a normal and a modified feed mode.

FIG. 5 illustrates a block diagram of an algorithm implemented by a digital signal processor for controlling a subscriber loop DC feed.

FIG. 6 illustrates one embodiment of a SLIC having the BORSCHT functions distributed between a signal processor and a linefeed driver.

### DETAILED DESCRIPTION

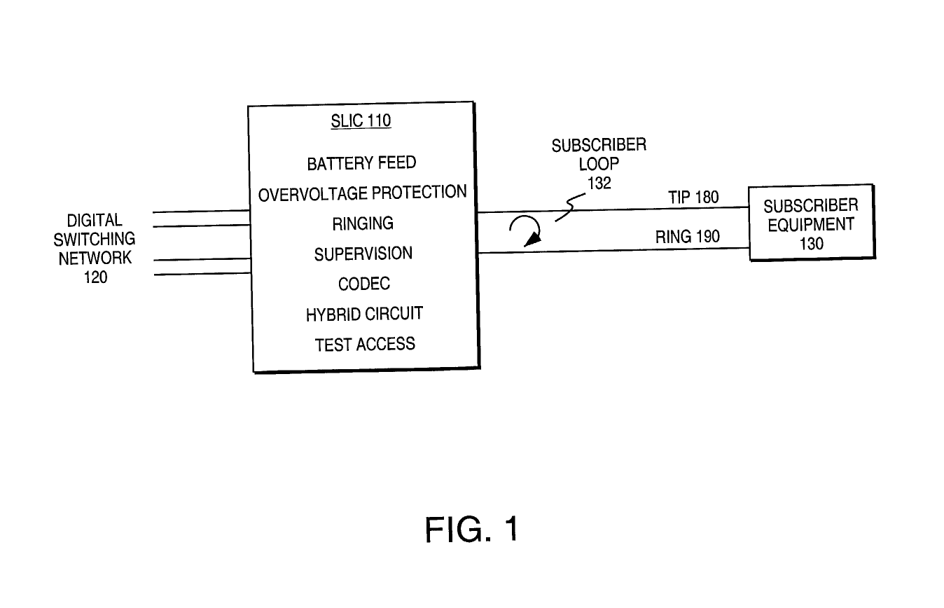

FIG. 1 illustrates functional elements of one embodiment of a subscriber line interface circuit (SLIC) 110 typically associated with plain old telephone services (POTS) telephone lines. The subscriber line interface circuit (SLIC) provides an interface between a digital switching network 120 of a local telephone company central exchange and a subscriber loop 132 including subscriber equipment 130.

The subscriber loop 132 is typically used for communicating analog data signals (e.g., voiceband communications) as well as subscriber loop “handshaking” or control signals. The analog data signals are typically on the order of 1 volt peak-to-peak (i.e., “small signal”). The subscriber loop control signals typically consist of a 48 V d.c. offset and an a.c. signal of 40-140 Vrms (i.e., “large signal”). The subscriber loop state is often specified in terms of the tip 180 and ring 190 portions of the subscriber loop.

The SLIC is expected to perform a number of functions often collectively referred to as the BORSCHT requirements. BORSCHT is an acronym for “battery feed,” “overvoltage protection,” “ring,” “supervision,” “codec,” “hybrid,” and “test.”

The SLIC provides power to the subscriber equipment 180 using the battery feed function. The overvoltage protection function serves to protect the central office circuitry against voltage transients that may occur on the subscriber loop 132. The ring function enables the SLIC to signal the subscriber equipment 180. In one embodiment, subscriber equipment 180 is a telephone. Thus, the ring function enables the SLIC to ring the telephone.

The supervision function enables the SLIC to detect service requests such as when the caller goes off-hook. The supervision function is also used to supervise calls in progress and to detect dialing input signals.

The hybrid function provides a conversion from two wire signaling to four wire signaling. The SLIC includes a codec to convert the four-wire analog voiceband data signal into serial digital codes suitable for transmission by the digital switching network 120. In one embodiment, pulse code modulation is used to encode the voiceband data. The SLIC also typically provides a means to test for or to indicate faults that may exist in the subscriber loop or the SLIC itself.

The codec function has relatively low power requirements and can be implemented in a low voltage integrated circuit operating in the range of approximately 5 volts or less. The battery feed and supervision circuitry typically operate in the range of 40-75 volts. In some implementations the ringing function is handled by the same circuitry as the battery feed and supervision circuitry. In other implementations, the ringing function is performed by higher voltage ringing circuitry (75-150 Vrms). Thus depending upon implementation, the ringing function as well as the overvoltage protection function may be associated with circuitry having greater voltage or current operating requirements than the other circuitry.

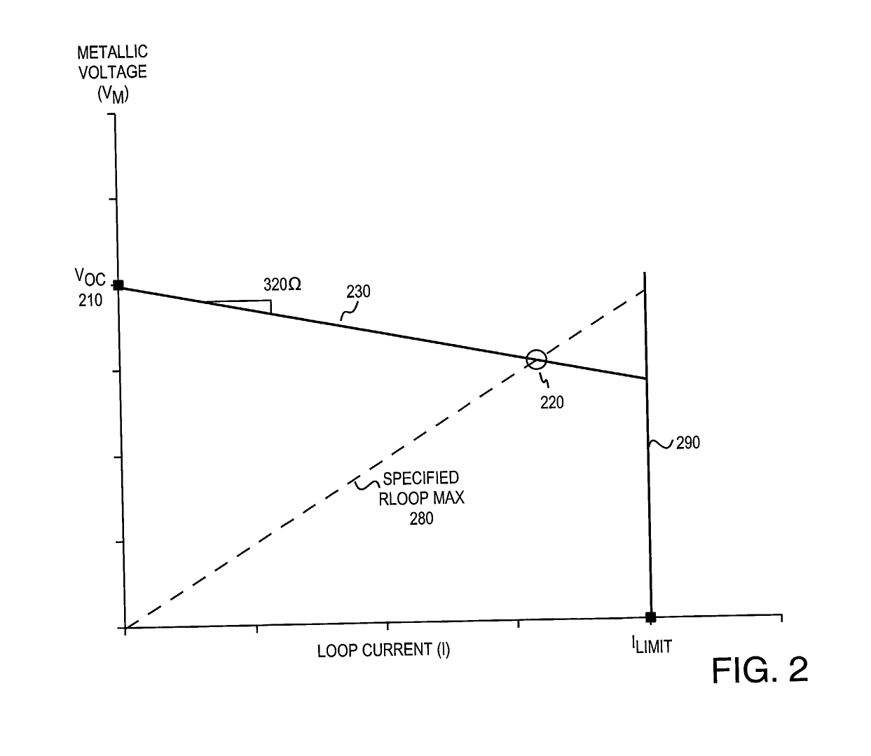

FIG. 2 illustrates one embodiment of a DC feed 230 provided by the SLIC. The SLIC is designed to maintained a desired predetermined ratio between the battery voltage and the loop current in the resistive region between the on-hook open circuit voltage (V_{OC} 210) and the constant current region (I_{LIMIT} 290). In one embodiment, the ratio defines an impedance of approximately 320 Ω.

The maximum loop impedance of 1930 Ω corresponding to the maximum length subscriber loop as specified in the standards is illustrated as segment 280. As indicated by the intersection of lines 230 and 280, as long as the predetermined ratio is maintained, there will be insufficient DC feed unless V_{OC} is sufficiently large to begin with. The battery voltage can be increased to increase V_{OC} and thus support the maximum length subscriber loop. This will result, however, in excessive power consumption for shorter length loops. Preferably, the SLIC should feed as long a loop as possible with the minimal battery voltage.

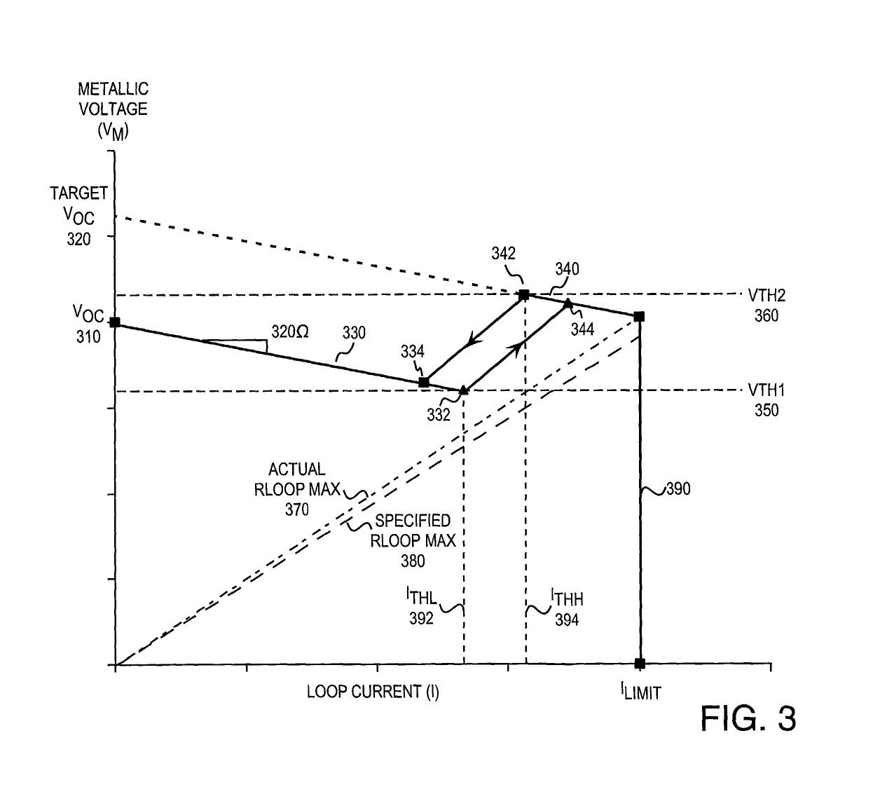

FIG. 3 illustrates a modified DC feed provided by the SLIC to accommodate short and long loop conditions. Hysteresis is introduced into the DC feed. When the subscriber equipment is off hook, the metallic voltage (i.e., V_{TIP}-V_{RING}) decreases and the SLIC ensures the DC feed follows a first characteristic curve 330. In this embodiment, the first characteristic curve is linear and is defined by a first open circuit voltage 310 and a pre-determined slope. The pre-determined slope corresponds to a pre-determined impedance of 320 Ω.

When the metallic voltage meets or falls below a first pre-determined threshold VTH1 350 at 332, control of the metallic voltage is shifted to a new value 344 and subsequently follows a second characteristic curve 340. In this embodiment, the second characteristic curve is linear and is defined by a target open circuit voltage 320 and a predetermined slope. In one embodiment, the slopes of the first and second characteristic curves are substantially the same.

This allows the SLIC to provide adequate feed to the maximum length loop defined by the specified RLOOP MAX line segment 380 (1930 Ω) without excessive power dissipation in the shorter length loops. The new value 344 is selected to ensure that the metallic voltage will meet or exceed the voltage defined by the intersection of the 1930 Ω line segment 380 and the current limited segment 390. The intersection of the second characteristic curve 340 with the current limit segment 390 defines the ACTUAL RLOOP MAX segment 370.

When the subscriber equipment is placed on hook, the metallic voltage increases along the second characteristic curve 340. When the metallic voltage reaches or starts to exceed a second pre-determined threshold 360 at point 342, the metallic voltage is decreased to point 334 and follows the first characteristic curve 340 associated with the original open circuit voltage 310.

The voltage thresholds effectively establish current thresholds for given characteristic curves. The DC feed behavior may be restated with reference to these current thresholds. In particular, the subscriber loop is provided with a normal DC feed following a first characteristic curve as long as the subscriber loop current is less than a first current threshold, I_{THL} 392. The subscriber loop is provided with a modified DC feed following a second characteristic curve as long as the subscriber loop current is greater than a second current threshold, I_{THH} 394 (at least until the maximum subscriber loop current, LIMIT 390 is reached). Control switches from the normal feed to the modified feed when the subscriber loop current exceeds I_{THL}. Control switches from the modified feed to the normal feed with the subscriber loop current falls below I_{THH}.

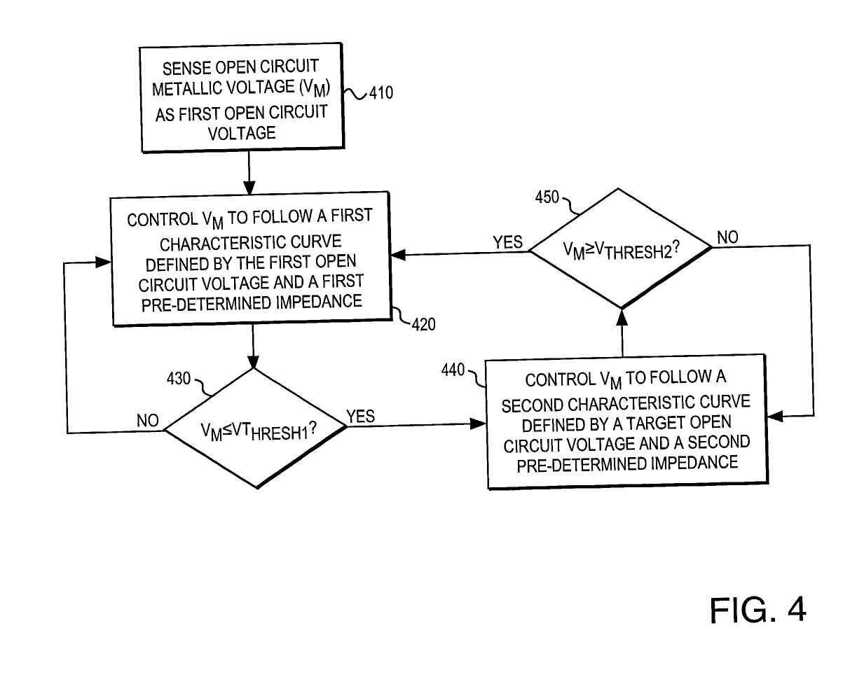

FIG. 4 illustrates a method of controlling the metallic voltage in accordance with FIG. 3. In step 410, the open circuit voltage is sensed as the first open circuit voltage. When the subscriber equipment is taken off hook, the metallic voltage is controlled to follow a first characteristic curve defined by the first open circuit voltage and a pre-determined impedance in step 420.

Step 430 determines whether the metallic voltage meets or falls below a first threshold (i.e., V_{M}≦V_{THRESH1}). If so, then control of the DC feed switches to a modified feed state. The metallic voltage is increased to a value on a second characteristic curve defined by a target open circuit voltage and the predetermined impedance in step 440. This characteristic curve is followed as necessary until the maximum loop current is met.

If the metallic voltage meets or exceeds the second threshold (i.e., V_{M}≧V_{THRESH2}) as determined by step 450, then the metallic voltage is shifted to follow the first characteristic curve again in step 420. When the second threshold is reached, control of the DC feed switches back to normal operation, thus exiting the modified feed state.

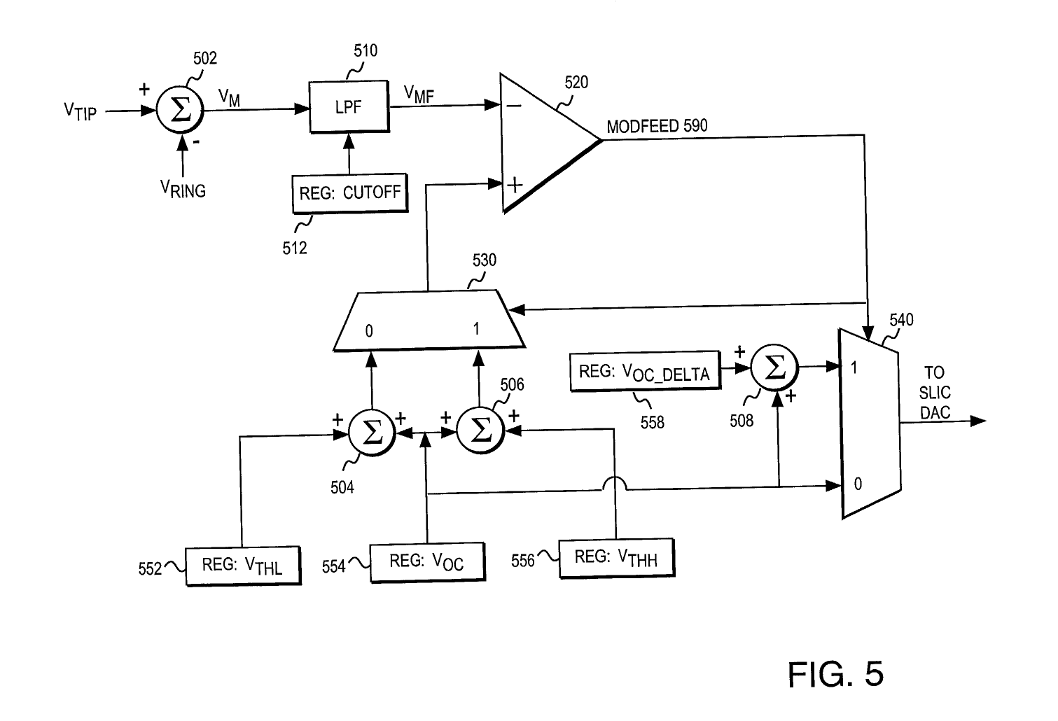

In one embodiment the DC feed characteristic is controlled by an algorithm executing on a digital signal processor residing within the SLIC. FIG. 5 illustrates a block diagram of one embodiment of such an algorithm. The first and second characteristic curves are programmable. The predetermined impedance, effective target open circuit voltage, maximum loop current (I_{LIMIT}) and effective first and second threshold voltages are all programmable.

The metallic voltage is calculated using summer 502 to compute the difference between the sensed tip and ring voltages (e.g., V_{M}=V_{TIP}−V_{RING}). The calculated metallic voltage is filtered through low pass filter 510 to remove noise and thus estimate the true metallic voltage. User register 512 defines a cutoff value for low pass filter 510. The filtered metallic voltage, V_{MF}, is then provided to comparator 520. Comparator 520 asserts the MODFEED 590 signal to indicate when the SLIC should operate in modified feed mode. MODFEED 590 is asserted only when the output of multiplexer 530 exceeds V_{MF}.

User register 554 stores the programmed open circuit voltage, V_{OC}. This value may vary depending upon the battery and subscriber loop conditions. In this embodiment, the upper and lower thresholds are defined relative to V_{OC}. Thus the value in register 552 (V_{THL}) is added to V_{OC} using summer 504 to establish the first or lower threshold. Similarly, the value in register 556 (V_{THH}) is added to V_{OC} using summer 506 to establish the second or upper threshold. Multiplexer 530 thus selects either the lower or upper threshold for comparator 520 in accordance with the MODFEED 590 signal.

When MODFEED 590 is de-asserted, multiplexer 540 provides V_{OC} to a SLIC digital to analog converter (DAC). The DAC is part of another control system that establishes the DC feed characteristic. In this case the other control system maintains a pre-determined DC feed impedance. Given that both the first and second characteristic curves are linear and have the same slope, the y-intercept is sufficient to establish operation in the modified feed or normal mode.

Thus when MODFEED 590 is de-asserted, multiplexer 540 provides V_{OC} thus ensuring control in accordance with the first characteristic curve. Once the first threshold is reached, however, MODFEED 590 is asserted, thus selecting the target open circuit voltage. Register 558 defines the difference between the target open circuit voltage and V_{OC} as V_{OC}_{_{—}}_{DELTA}. The target open circuit value is calculated as V_{OC}+V_{OC}_{_{—}}_{DELTA} using summer 508.

Although the characteristic curves presented in the preceding examples are linear and have the same slope, in alternative embodiments the first and second characteristic curves have distinct slopes. Other embodiments may use combinations of curvilinear and linear segments for the first and second characteristic curves such that one or the other or both characteristic curves are nonlinear.

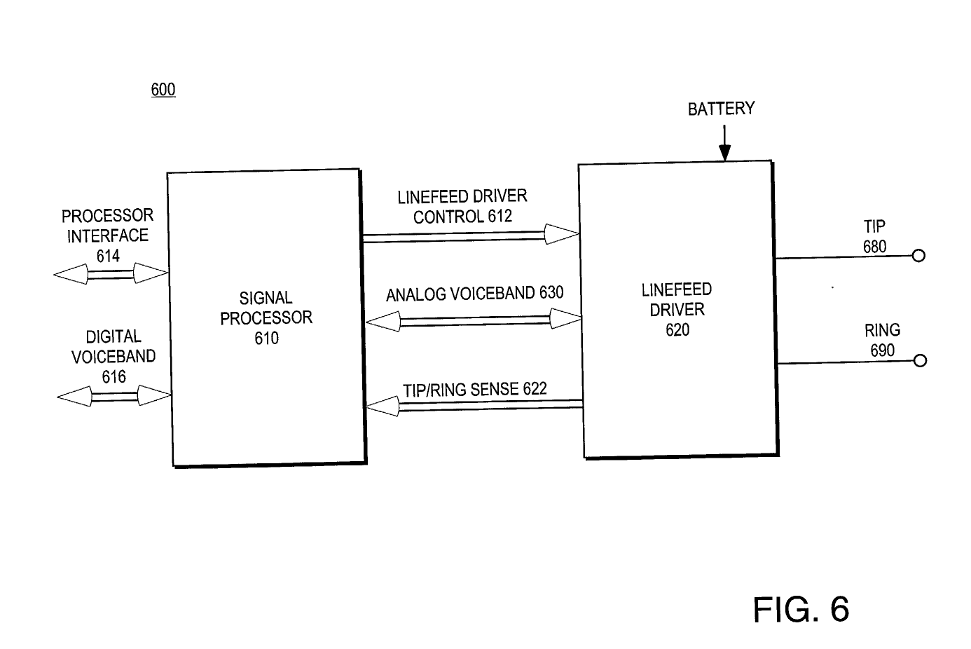

FIG. 6 illustrates one embodiment of an SLIC 600 wherein the BORSCHT functions have been distributed between a signal processor 610 and a linefeed driver 620. Signal processor 610 is responsible for at least the ring control, supervision, codec, and hybrid functions. Signal processor 610 controls and interprets the large signal subscriber loop control signals as well as handling the small signal analog voiceband data and the digital voiceband data. The linefeed driver 620 performs various functions such as DC feed to the subscriber loop (i.e., tip 680 and ring 690) in response to the control signals from signal processor 610.

In one embodiment, signal processor 610 is an integrated circuit. The integrated circuit includes sense inputs for a sensed tip and ring signal of the subscriber loop. The integrated circuit generates subscriber loop linefeed driver control signal in response to the sensed signals.

Signal processor 610 receives subscriber loop state information from linefeed driver 620 as indicated by tip/ring sense 622. This information is used to generate control signals for linefeed driver 620 as indicated by linefeed driver control 612. The voiceband 630 signal is used for bi-directional communication of the analog voiceband data between linefeed driver 620 and signal processor 610.

Signal processor 610 includes a digital interface for communicating digitized voiceband data to the digital switching network using digital voiceband 616. In one embodiment, the digital interface includes a processor interface 614 to enable programmatic control of the signal processor 610. The processor interface effectively enables programmatic or dynamic control of battery control, battery feed state control, voiceband data amplification and level shifting, longitudinal balance, ringing currents, and other subscriber loop control parameters as well as setting thresholds such as a ring trip detection thresholds and an off-hook detection threshold. Thus, for example, the user registers of FIG. 5 can be accessed through the processor interface 614. Signal processor 610 may incorporate one or more digital signal processors for implementing the control algorithm illustrated in FIG. 5.

In the preceding detailed description, the invention is described with reference to specific exemplary embodiments thereof. Various modifications and changes may be made thereto without departing from the broader spirit and scope of the invention as set forth in the claims. The specification and drawings are, accordingly, to be regarded in an illustrative rather than a restrictive sense.

What is claimed is:

1. A method of controlling a DC feed from a subscriber loop interface circuit (SLIC), comprising the steps of:
switching from a normal mode DC feed following a first characteristic curve to a modified mode DC feed following a second characteristic curve when V_{M}≦V_{THRESH1}, wherein V_{M} is a subscriber loop voltage; and
switching from the modified mode to the normal mode when V_{M}≧V_{THRESH2}, wherein V_{THRESH1}<V_{THRESH2}.

2. The method of claim 1 wherein the first characteristic curve is linear, wherein the first characteristic curve is defined by an open circuit voltage, V_{OC}, and a slope corresponding to a pre-determined impedance.

3. The method of claim 1 wherein the first characteristic curve is linear, wherein the second characteristic curve is defined by a target open circuit voltage, V_{OC}_{_{—}}_{TARGET}, and a slope corresponding to a pre-determined impedance.

4. The method of claim 1 wherein the first and second characteristic curves are linear, wherein the first characteristic curve is defined by an open circuit voltage, V_{OC}, and a pre-determined slope, wherein the second characteristic curve is defined by a target open circuit voltage, V_{OC}_{_{—}}_{TARGET}, and the same pre-determined slope corresponding to a pre-determined impedance.

5. The method of claim 4 wherein the pre-determined impedance is approximately 320 Ω.

6. A subscriber loop interface circuit apparatus comprising:
control circuitry for controlling a subscriber loop DC feed; and
a plurality of programmable registers storing values defining a first characteristic curve and a second characteristic curve, wherein the control circuitry switches from a normal mode DC feed following a first characteristic curve to a modified mode DC feed following a second characteristic curve when V_{M}≦V_{THRESH1}, wherein V_{M} is a subscriber loop voltage, wherein the control circuitry switches from the modified mode to the normal mode when V_{M}≧V_{THRESH2}, wherein V_{THRESH1}<V_{THRESH2}.

7. The apparatus of claim 6 further comprising a digital signal processor.

8. The apparatus of claim 6, wherein one of the plurality of programmable registers stores an open circuit voltage value, wherein the open circuit voltage value in conjunction with a pre-determined slope defines a linear first characteristic curve.

9. The apparatus of claim 6, wherein one of the plurality of programmable registers stores a value enabling computation of a target open circuit voltage value, wherein the target open circuit voltage value in conjunction with a pre-determined slope defined a linear second characteristic curve.

10. The apparatus of claim 9 wherein the plurality of registers store an open circuit voltage value (V_{OC}), a first relative threshold (V_{THL}), a second relative threshold (V_{THH}), and a relative target open circuit voltage (V_{OC}_{_{—}}_{DELTA}), wherein V_{THRESH1}=V_{OC}+V_{THL}, V_{THRESH2}=V_{OC}+V_{THH}, and the target open circuit voltage=V_{OC}+V_{OC}_{_{—}}_{DELTA}.

11. The apparatus of claim 6 wherein the first and second characteristic curves are linear, wherein the first characteristic curve is defined by an open circuit voltage, V_{OC}, and a pre-determined slope, wherein the second characteristic curve is defined by a target open circuit voltage, V_{OC}_{_{—}}_{TARGET}, and the same pre-determined slope corresponding to a pre-determined impedance.

12. The apparatus of claim 11 wherein the pre-determined impedance is approximately 320 Ω.
